(19) United States
(12) Patent Application Publication
(10) Pub. No.: US 2025/0337856 A1
(43) Pub. Date: Oct. 30, 2025

(54) VIDEO PROCESSING DEVICE AND VIDEO PROCESSING METHOD SUPPORTING FREE PAIRING OF PICTURE-IN-PICTURE MODE AND PICTURE-BY-PICTURE MODE

(71) Applicant: REALTEK SEMICONDUCTOR CORP., HSINCHU (TW)

(72) Inventors: Yuh-Wey Lin, HSINCHU (TW); TZUO-BO LIN, HSINCHU (TW); CHIH-HAN YANG, HSINCHU (TW); YU-CHANG TSAI, HSINCHU (TW)

(21) Appl. No.: 19/186,815

(22) Filed: Apr. 23, 2025

(30) Foreign Application Priority Data
Apr. 25, 2024 (TW) 113115368

(51) Int. Cl. H04N 5/45; H04N 5/262

(52) U.S. Cl. CPC H04N 5/45; H04N 5/2628

(57) ABSTRACT

A video processing device and a video processing method supporting free pairing of a picture-in-picture mode and a picture-by-picture mode are provided. The video processing device includes a first hub, a second hub, and a scaling control module. The first hub obtains a first video stream from a first signal source, and the second hub obtains a second video stream from a second signal source. The scaling control module obtains the first video stream and the second video stream respectively from the first hub and the second hub. When the scaling control module receives a picture-in-picture mode command, the scaling control module combines the first video stream and the second video stream to generate a picture-in-picture video stream. When the scaling control module receives a picture-by-picture mode command, the scaling control module combines the first video stream and the second video stream to generate a picture-by-picture video stream.

### CROSS-REFERENCE TO RELATED PATENT APPLICATION

This application claims the benefit of priority to Taiwan Patent Application No. 113115368, filed on Apr. 25, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a video processing device and a video processing method, and more particularly to a video processing device and a video processing method supporting free pairing of a picture-in-picture mode and a picture-by-picture mode.

### BACKGROUND OF THE DISCLOSURE

Currently, there is a video processing device that can act as a transmission bridge between multiple video sources and multiple displayers. Such video processing device can be connected to a keyboard and a mouse, and a user can use the keyboard or the mouse to generate commands for switching pairing relationships of the video sources and the displayers, so that the user can adjust picture configuration of the image according to personal preferences or characteristics of the video sources and the displayers.

However, the existing video processing device can only support application where a single video stream is displayed on a single displayer, and cannot support application where multiple video streams correspond to multiple displayers or achieve application of a picture-in-picture mode and a picture-by-picture mode.

### SUMMARY OF THE DISCLOSURE

In response to the above-referenced technical inadequacy, the present disclosure provides a video processing device and a video processing method supporting free pairing of a picture-in-picture mode and a picture-by-picture mode.

In order to solve the above-mentioned problem, one of the technical aspects adopted by the present disclosure is to provide a video processing device supporting free pairing of a picture-in-picture mode and a picture-by-picture mode. The video processing device is adapted to a first display device, and the video processing device includes a first hub, a second hub, and a first scaling control module. The first hub is configured to obtain a first video stream from a first signal source. The second hub is configured to obtain a second video stream from a second signal source. The first scaling control module is connected to the first hub and the second hub. When the first scaling control module receives a picture-in-picture mode command, the first scaling control module combines the first video stream and the second video stream to generate a first picture-in-picture video stream and the first display device displays the first picture-in-picture video stream. When the first scaling control module receives a picture-by-picture mode command, the first scaling control module combines the first video stream and the second video stream to generate a first picture-by-picture video stream and the first display device displays the first picture-by-picture video stream.

In order to solve the above-mentioned problem, another one of the technical aspects adopted by the present disclosure is to provide a video processing method supporting free pairing of a picture-in-picture mode and a picture-by-picture mode. The video processing method includes: obtaining, by a first hub, a first video stream from a first signal source; obtaining, by second hub, a second video stream from a second signal source; and receiving, by a first scaling control module, the first video stream and the second video stream respectively from the first hub and the second hub. When the first scaling control module receives a picture-in-picture mode command, the first scaling control module combines the first video stream and the second video stream to generate a first picture-in-picture video stream and a first display device displays the first picture-in-picture video stream. When the first scaling control module receives a picture-by-picture mode command, the first scaling control module combines the first video stream and the second video stream to generate a first picture-by-picture video stream and the first display device displays the first picture-by-picture video stream.

Therefore, in the video processing device and the video processing method supporting free pairing of the picture-in-picture mode and the picture-by-picture mode provided by the present disclosure, users can control multiple different video streams provided by multiple different signal sources according to different needs, and these video streams can be displayed on a display device in the picture-in-picture mode or the picture-by-picture mode.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a video processing device pairing with a picture-in-picture video stream according to a first embodiment of the present disclosure;

FIG. 2 is a schematic diagram of the video processing device pairing with a picture-by-picture video stream according to the first embodiment of the present disclosure;

FIG. 3 is a flowchart of a video processing method supporting free pairing of a picture-in-picture mode and a picture-by-picture mode according to the first embodiment of the present disclosure;

FIG. 4 is a schematic diagram of the video processing device pairing with the picture-in-picture video stream according to a second embodiment of the present disclosure;

FIG. 5 is a flowchart of the video processing method supporting free pairing of the picture-in-picture mode and the picture-by-picture mode according to the second embodiment of the present disclosure; and

FIG. 6 is a schematic diagram of the video processing device pairing with the picture-in-picture video stream and the picture-by-picture video stream according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

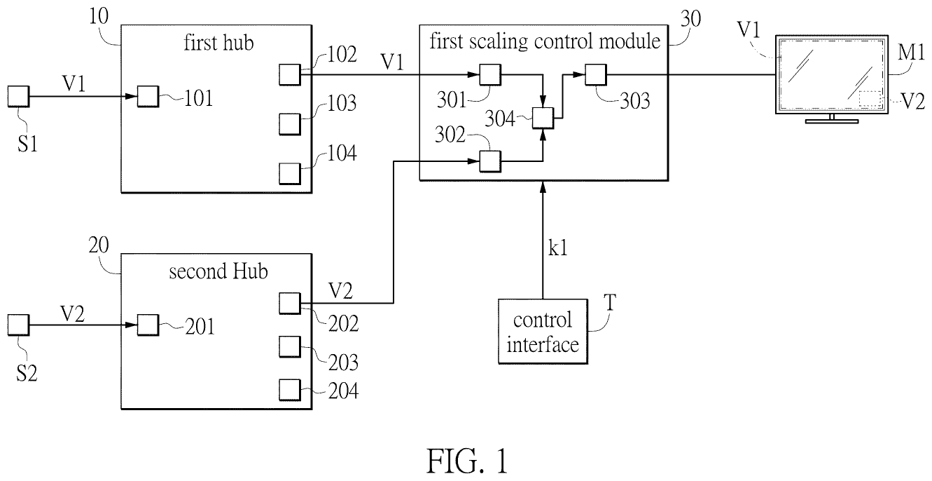

FIG. 1 is a schematic diagram of a video processing device pairing with a picture-in-picture video stream according to a first embodiment of the present disclosure. Referring to FIG. 1, the video processing device includes a first hub 10, a second hub 20, and a first scaling control module 30. In this embodiment, the first hub 10 and the second hub 20 are two identical display port (DP) hubs. The first hub 10 includes a video input port 101, a first video output port 102, a second video output port 103, and a third video output port 104. The second hub 20 includes a video input port 201, a first video output port 202, a second video output port 203, and a third video output port 204. The video input port 101 of the first hub 10 is used to connect to a first signal source S1 for receiving a first video stream V1. The video input port 201 of the second hub 20 is used to connect to a second signal source S2 for receiving a second video stream V2. The video specifications, the quantity of the video input ports, and the quantity of the video output ports mentioned above are only examples, and the present disclosure is not limited thereto.

The first scaling control module 30 includes a first video input port 301, a second video input port 302, a video output port 303, and a video synthesis circuit 304, and the video synthesis circuit 304 is connected to the first video input port 301, the second video input port 302, and the video output port 303.

The first video input port 301 is connected to the first video output port 102 of the first hub 10, the second video input port 302 is connected to the first video output port 202 of the second hub 20, and the video output port 303 is connected to a first display device M1.

When a user needs the first video stream V1 of the first signal source S1 and the second video stream V2 of the second signal source S2 to be displayed on the first display device M1 in a picture-in-picture mode, the user operates a control interface T to transmit a picture-in-picture mode command k1 to the first scaling control module 30.

For example, the control interface T includes a mouse and a keyboard. When the user presses a first button (e.g. F1) of the keyboard, the control interface T transmits the picture-in-picture mode command k1 to the first scaling control module 30.

When the first scaling control module 30 receives the picture-in-picture mode command k1 from the control interface T, the video synthesis circuit 304 enables the first video stream V1 and the second video stream V2 to overlap with each other according to the picture-in-picture mode command k1, so as to generate a picture-in-picture video stream. In addition, the first display device M1 displays the picture-in-picture video stream.

When the first display device M1 displays the picture-in-picture video stream, the first display device M1 displays a first sub-picture and a second sub-picture that overlap with each other. An area of the first sub-picture is greater than an area of the second sub-picture, and the first sub-picture and the second sub-picture respectively display the first video stream V1 and the second video stream V2.

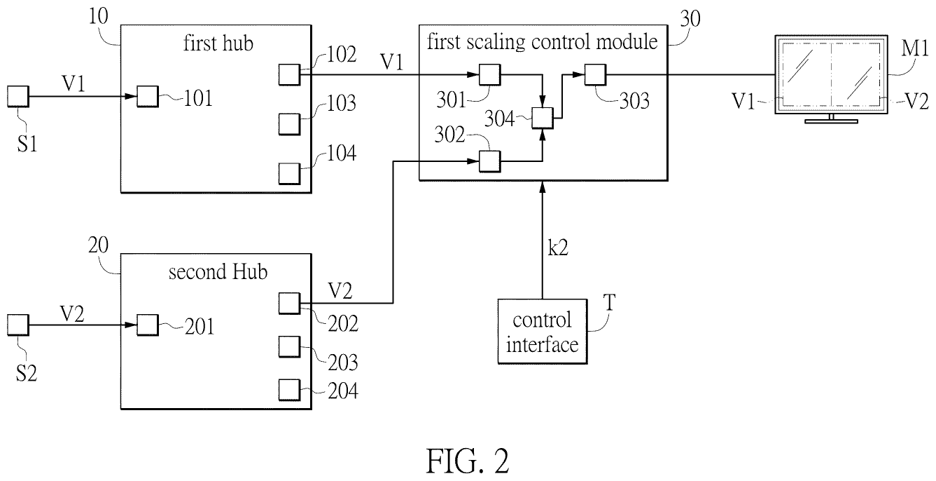

FIG. 2 is a schematic diagram of a video processing device pairing with a picture-by-picture video stream according to the first embodiment of the present disclosure. A comparison is made between FIG. 1 and FIG. 2, and differences between FIG. 1 and FIG. 2 are described below. When the user needs the first video stream V1 of the first signal source S1 and the second video stream V2 of the second signal source S2 to be displayed on the first display device M1 in a picture-by-picture mode, the user operates the control interface T to transmit a picture-by-picture mode command k2 to the first scaling control module 30.

For example, when the user presses a second button (e.g. F2) of the keyboard, the control interface T transmits the picture-by-picture mode command k2 to the first scaling control module 30.

When the first scaling control module 30 receives the picture-by-picture mode command k2 from the control interface T, the video synthesis circuit 304 arranges the first video stream V1 and the second video stream V2 side by side according to the picture-by-picture mode command k2, so as to generate a picture-by-picture video stream. In addition, the first display device M1 displays the picture-by-picture video stream.

When the first display device M1 displays the picture-by-picture video stream, the first display device M1 displays a first sub-picture and a second sub-picture that are arranged side by side and do not overlap with each other. The area of the first sub-picture is equal to that of the second sub-picture, and the first sub-picture and the second sub-picture respectively display the first video stream V1 and the second video stream V2.

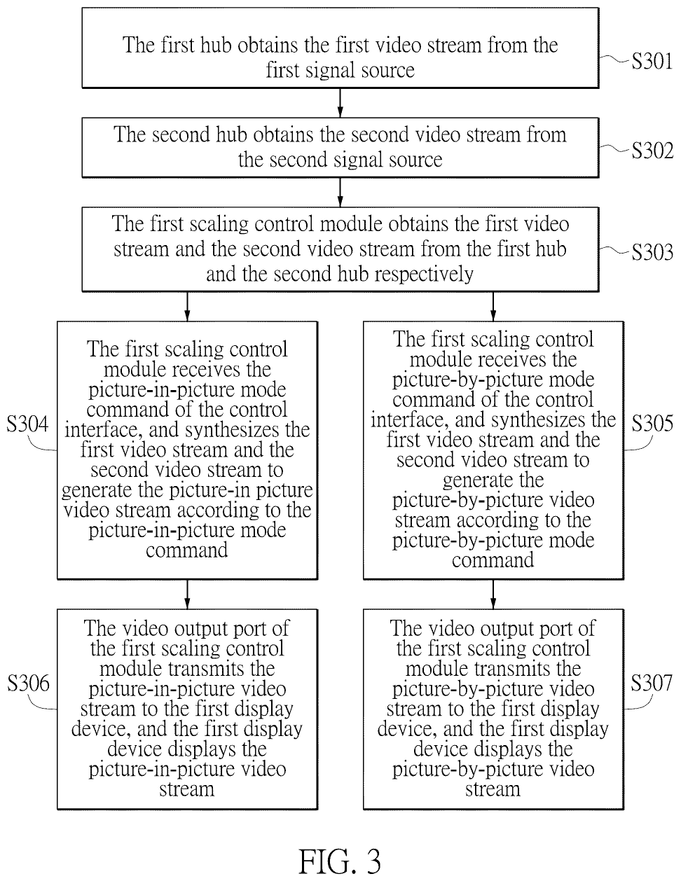

FIG. 3 is a flowchart of a video processing method supporting free pairing of a picture-in-picture mode and a picture-by-picture mode according to the first embodiment of the present disclosure. Referring to FIG. 3, in step S301, the first hub 10 obtains the first video stream V1 from the first signal source S1.

In step S302, the second hub 20 obtains the second video stream V2 from the second signal source S2.

In step S303, the first scaling control module 30 obtains the first video stream V1 and the second video stream V2 from the first hub 10 and the second hub 20 respectively.

In step S304, the first scaling control module 30 receives the picture-in-picture mode command k1 of the control interface T, and synthesizes the first video stream V1 and the second video stream V2 to generate the picture-in picture video stream according to the picture-in-picture mode command k1.

Specifically, the video synthesis circuit 304 of the first scaling control module 30 overlaps the first video stream V1 and the second video stream V2 with each other to generate the picture-in-picture video stream.

In step S305, the first scaling control module 30 receives the picture-by-picture mode command k2 of the control interface T, and synthesizes the first video stream V1 and the second video stream V2 to generate the picture-by-picture video stream according to the picture-by-picture mode command k2.

Specifically, the video synthesis circuit 304 of the first scaling control module 30 arranges the first video stream V1 and the second video stream V2 side by side to generate the picture-by-picture video stream.

In step S306, the video output port 303 of the first scaling control module 30 transmits the picture-in-picture video stream to the first display device M1, and the first display device M1 displays the picture-in-picture video stream.

In step S307, the video output port 303 of the first scaling control module 30 transmits the picture-by-picture video stream to the first display device M1, and the first display device M1 displays the picture-by-picture video stream.

Accordingly, multiple video streams provided by multiple signal sources can be selectively displayed on a display device in the picture-in-picture mode and the picture-by-picture mode.

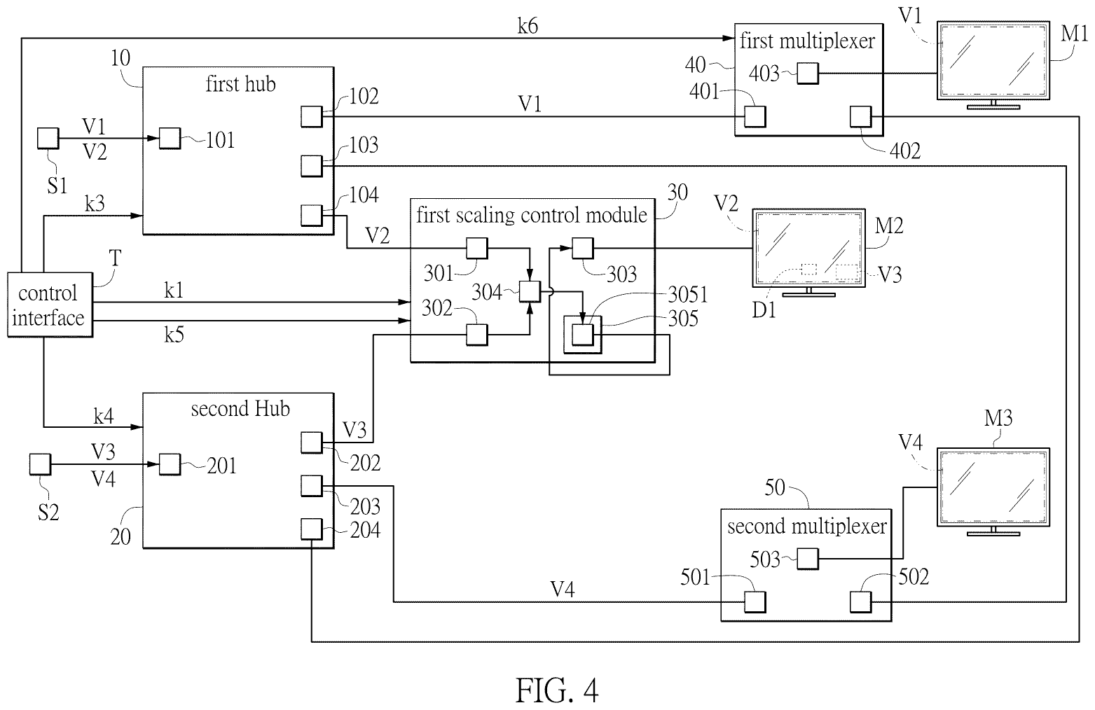

FIG. 4 is a schematic diagram of the video processing device pairing with the picture-in-picture video stream according to a second embodiment of the present disclosure. A comparison is made between FIG. 1 and FIG. 4, and differences between FIG. 1 and FIG. 4 are described below. The video processing device of FIG. 4 further includes a first multiplexer 40 and a second multiplexer 50. The first multiplexer 40 includes a first signal input terminal 401, a second signal input terminal 402, and a signal output terminal 403. The second multiplexer 50 includes a first signal input terminal 501, a second signal input terminal 502, and a signal output terminal 503. The first scaling control module 30 further includes a screen display processing circuit 305, and the screen display processing circuit 305 is connected to the video synthesis circuit 304. The screen display processing circuit 305 includes an embedded display output port 3051, and the embedded display output port 3051 is connected to the video output port 303.

The video input port 101 of the first hub 10 is used to connect to the first signal source S1 for receiving the first video stream V1 and the second video stream V2. The video input port 201 of the second hub 20 is used to connect to the second signal source S2 for receiving a third video stream V3 and a fourth video stream V4.

The first video output port 102, the second video output port 103, and the third video output port 104 of the first hub 10 are respectively connected to the first signal input terminal 401 of the first multiplexer 40, the second signal input terminal 502 of the second multiplexer 50, and the first video input port 301 of the first scaling control module 30.

The first video output port 202, the second video output port 203, and the third video output port 204 of the second hub 20 are respectively connected to the second video input port 302 of the first scaling control module 30, the first signal input terminal 501 of the second multiplexer 50, and the second signal input terminal 402 of the first multiplexer 40.

The signal output terminal 403 of the first multiplexer 40 is connected to the first display device M1, the video output port 303 of the first scaling control module 30 is connected to a second display device M2, and the signal output terminal 503 of the second multiplexer 50 is connected to a third display device M3.

Since the user needs the first display device M1 to display the first video stream V1, needs the second display device M2 to display the second video stream V2 and the third video stream V3 in the picture-in-picture mode, and needs the third display device M3 to display the fourth video stream V4, the user operates the control interface T to transmit a first path command k3 to the first hub 10, a second path command k4 to the second hub 20, the picture-in-picture mode command k1 and an on-screen display activation command k5 to the first scaling control module 30, a first control signal k6 to the first multiplexer 40, and a second control signal to the second multiplexer 50.

According to the first path command k3, the first hub 10 outputs the first video stream V1 and the second video stream V2 via the first video output port 102 and the third video output port 104, respectively. According to the second path command k4, the second hub 20 outputs the third video stream V3 and the fourth video stream V4 via the first video output port 202 and the second video output port 203, respectively.

The video synthesis circuit 304 enables the second video stream V2 and the third video stream V3 to overlap with each other according to the picture-in-picture mode command k1, so as to generate the picture-in-picture video stream. In addition, the video synthesis circuit 304 transmits the picture-in-picture video stream to the screen display processing circuit 305.

The screen display processing circuit 305 generates an on-screen display menu D1 according to the on-screen display activation command k5. The on-screen display menu D1 includes color information, color temperature information, contrast information, brightness information, backlight information, resolution information, and subtitle information.

The screen display processing circuit 305 embeds the on-screen display menu D1 in the picture-in-picture video stream, and transmits the picture-in-picture video stream including the screen display menu D1 to the video output port 303 of the first scaling control module 30 through the embedded display output port 3051. The video output port 303 of the first scaling control module 30 transmits the picture-in-picture video stream including the on-screen display menu D1 to the second display device M2. The second display device M2 displays a first sub-picture and a second sub-picture that overlap each other according to the picture-in-picture video stream including the on-screen display menu D1. The first sub-picture and the second sub-picture respectively display the second video stream V2 and the third video stream V3, and the on-screen display menu D1 overlaps the first sub-picture.

The first multiplexer 40 transmits the first video stream V1 to the first display device M1 according to the first control signal k6, and the first display device M1 displays the first video stream V1.

The second multiplexer 50 transmits the fourth video stream V4 to the third display device M3 according to the second control signal k7, and the third display device M3 displays the fourth video stream V4.

Accordingly, multiple video streams provided by multiple signal sources can be displayed on different display devices in a normal mode and the picture-in-picture mode.

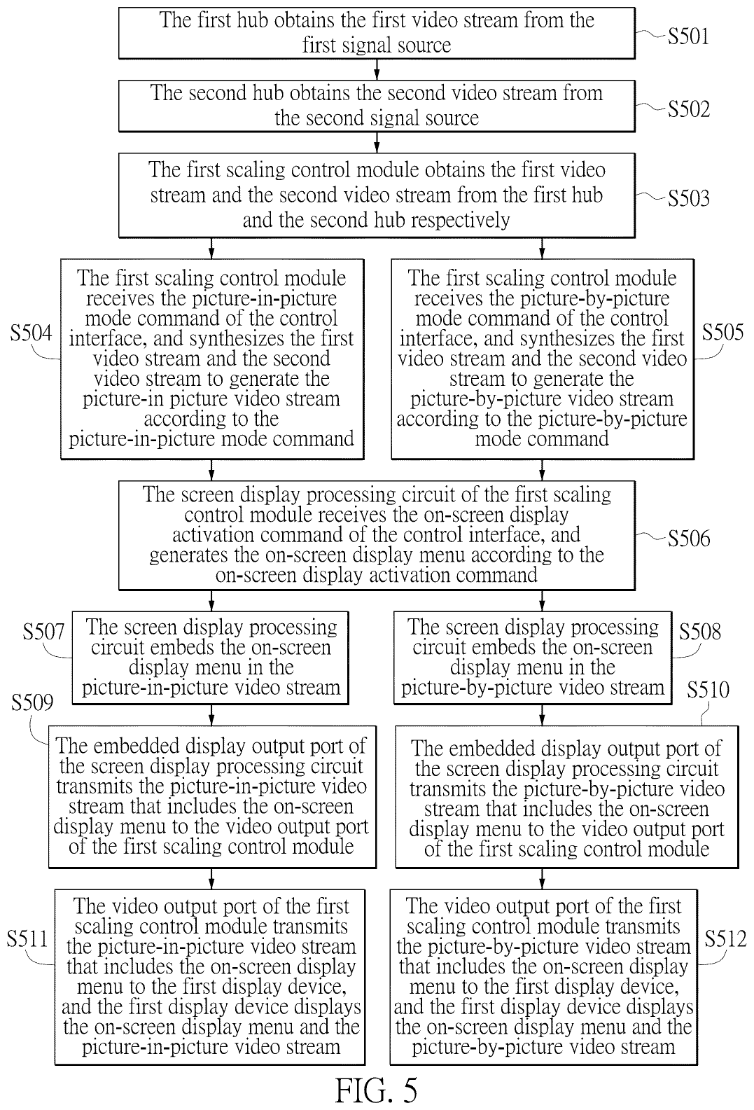

FIG. 5 is a flowchart of the video processing method supporting free pairing of the picture-in-picture mode and the picture-by-picture mode according to the second embodiment of the present disclosure. Steps S501 to S505 of FIG. 5 respectively correspond to steps S301 to S305 of FIG. 3. Differences between FIG. 5 and FIG. 3 are described below.

In step S506, the screen display processing circuit 305 of the first scaling control module 30 receives the on-screen display activation command k5 of the control interface T, and generates the on-screen display menu D1 according to the on-screen display activation command k5.

In step S507, the screen display processing circuit 305 embeds the on-screen display menu D1 in the picture-in-picture video stream.

In step S508, the screen display processing circuit 305 embeds the on-screen display menu D1 in the picture-by-picture video stream.

In step S509, the embedded display output port 3051 of the screen display processing circuit 305 transmits the picture-in-picture video stream that includes the on-screen display menu D1 to the video output port 303 of the first scaling control module 30.

In step S510, the embedded display output port 3051 of the screen display processing circuit 305 transmits the picture-by-picture video stream that includes the on-screen display menu D1 to the video output port 303 of the first scaling control module 30.

In step S511, the video output port 303 of the first scaling control module 30 transmits the picture-in-picture video stream that includes the on-screen display menu D1 to the first display device M1, and the first display device M1 displays the on-screen display menu D1 and the picture-in-picture video stream.

In step S512, the video output port 303 of the first scaling control module 30 transmits the picture-by-picture video stream that includes the on-screen display menu D1 to the first display device M1, and the first display device M1 displays the on-screen display menu D1 and the picture-by-picture video stream.

Accordingly, multiple video streams provided by multiple signal sources can be selectively displayed on different display devices in the picture-by-picture mode and the picture-in-picture mode. Each display device displays the on-screen display menu for the user to adjust color information, color temperature information, contrast information, brightness information, backlight information, resolution information, and subtitle information.

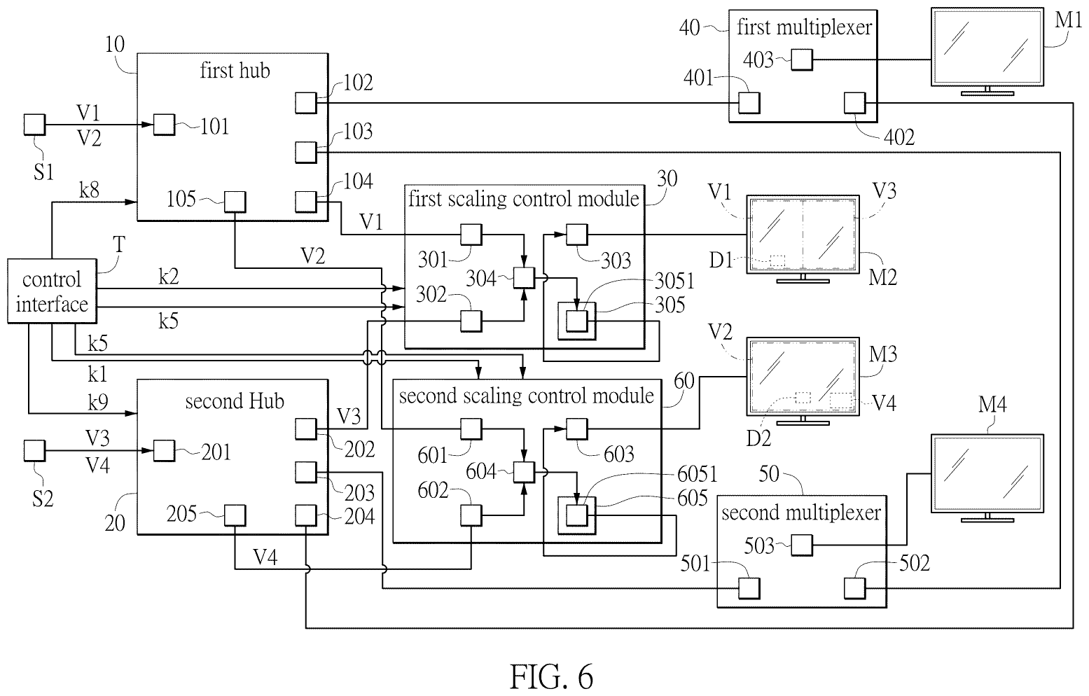

FIG. 6 is a schematic diagram of the video processing device pairing with the picture-in-picture video stream and the picture-by-picture video stream according to a third embodiment of the present disclosure. Differences between FIG. 6 and FIG. 4 are described below. The video processing device of FIG. 6 further includes a second scaling control module 60. The second scaling control module 60 includes a first video input port 60, a second video input port 602, a video output port 603, a video synthesis circuit 604, and a screen display processing circuit 605. The first video input port 601 and the second video input port 602 are connected to the video synthesis circuit 604, and the video synthesis circuit 604 is connected to the screen display processing circuit 605. The screen display processing circuit 605 includes an embedded display output port 6051, and the embedded display output port 6051 is connected to the video output port 603.

The first hub 10 further includes a fourth video output port 105, and the second hub 20 further includes a fourth video output port 205.

The fourth video output port 105 of the first hub 10 is connected to the first video input port 601 of the second scaling control module 60, and the fourth video output port 205 of the second hub 20 is connected to the second video input port 602 of the second scaling control module 60.

The video output port 603 of the second scaling control module 60 is connected to the third display device M3, and the signal output terminal 503 of the second multiplexer 50 is connected to a fourth display device M4.

Since the user needs the second display device M2 to display the first video stream V1 and the third video stream V3 in the picture-by-picture mode, and needs the third display device M3 to display the second video stream V2 and the fourth video stream V4 in the picture-in-picture mode, the user operates the control interface T to transmit a third path command k8 to the first hub 10, a fourth path command k9 to the second hub 20, the picture-by-picture mode command k2 and the on-screen display activation command k5 to the first scaling control module 30, and the picture-in-picture mode command k1 and the on-screen display activation command k5 to the second scaling control module 60.

According to the third path command k8, the first hub 10 outputs the first video stream V1 and the second video stream V2 via the third video output port 104 and the fourth video output port 105, respectively. According to the fourth path command k9, the second hub 20 outputs the third video stream V3 and the fourth video stream V4 via the first video output port 202 and the fourth video output port 205, respectively.

The video synthesis circuit 304 arranges the first video stream V1 and the third video stream V3 side by side according to the picture-by-picture mode command k2, so as to generate the picture-by-picture video stream. In addition, the video synthesis circuit 304 transmits the picture-by-picture video stream to the screen display processing circuit 305.

The screen display processing circuit 305 generates the on-screen display menu D1 according to the on-screen display activation command k5. The screen display processing circuit 305 embeds the on-screen display menu D1 in the picture-by-picture video stream, and transmits the picture-by-picture video stream that includes the on-screen display menu D1 to the video output port 303 of the first scaling control module 30 through the embedded display output port 3051. The video output port 303 of the first scaling control module 30 transmits the picture-by-picture video stream that includes the on-screen display menu D1 to the second display device M2.

The second display device M2 displays the first sub-picture and the second sub-picture that are arranged side by side and do not overlap with each other according to the picture-by-picture video stream that includes the on-screen display menu D1. The first sub-picture and the second sub-picture respectively display the first video stream V1 and the third video stream V3, and the on-screen display menu D1 overlaps with the first sub-picture.

The video synthesis circuit 604 enables the second video stream V2 and the fourth video stream V4 to overlap with each other according to the picture-in-picture mode command k1, so as to generate the picture-in-picture video stream. In addition, the video synthesis circuit 604 transmits the picture-in-picture video stream to the screen display processing circuit 605.

The screen display processing circuit 605 generates an on-screen display menu D2 according to the on-screen display activation command k5. The on-screen display menu D2 includes color information, color temperature information, contrast information, brightness information, backlight information, resolution adjustment image information, and subtitle information.

The screen display processing circuit 605 embeds the on-screen display menu D2 in the picture-in-picture video stream, and transmits the picture-in-picture video stream that includes the on-screen display menu D2 to the video output port 603 of the second scaling control module 60 through the embedded display output port 6051. The video output port 603 of the second scaling control module 60 transmits the picture-in-picture video stream that includes the on-screen display menu D2 to the third display device M3.

The third display device M3 displays the first sub-picture and the second sub-picture that overlap with each other according to the picture-in-picture video stream that includes the on-screen display menu D2. The first sub-picture and the second sub-picture respectively display the second video stream V2 and the fourth video stream V4, and the screen display menu D2 overlaps with the first sub-picture.

Accordingly, multiple video streams provided by multiple signal sources can be displayed on different display devices in the picture-by-picture mode and the picture-in-picture mode. Each display device displays the on-screen display menu for the user to adjust color information, color temperature information, contrast information, brightness information, backlight information, resolution information, and subtitle information.

### Beneficial Effects of the Embodiments

In conclusion, in the video processing device and the video processing method supporting free pairing of the picture-in-picture mode and the picture-by-picture mode provided by the present disclosure, the user can control multiple different video streams provided by multiple different signal sources according to different needs, and these video streams can be displayed on the display device in the picture-in-picture mode or the picture-by-picture mode. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A video processing device supporting free pairing of a picture-in-picture mode and a picture-by-picture mode, which is adapted to a first display device, the video processing device comprising:
a first hub, wherein the first hub is configured to obtain a first video stream from a first signal source;
a second hub, wherein the second hub is configured to obtain a second video stream from a second signal source; and
a first scaling control module connected to the first hub and the second hub;
wherein, when the first scaling control module receives a picture-in-picture mode command, the first scaling control module combines the first video stream and the second video stream to generate a first picture-in-picture video stream, and the first display device displays the first picture-in-picture video stream;
wherein, when the first scaling control module receives a picture-by-picture mode command, the first scaling control module combines the first video stream and the second video stream to generate a first picture-by-picture video stream, and the first display device displays the first picture-by-picture video stream.

2. The video processing device according to claim 1, wherein the first scaling control module includes a video synthesis circuit, and the video synthesis circuit enables the first video stream and the second video stream to overlap with each other according to the picture-in-picture mode command, so as to generate the first picture-in-picture video stream; wherein the first scaling control module arranges the first video stream and the second video stream side by side according to the picture-by-picture mode command, so as to generate the first picture-by-picture video stream.

3. The video processing device according to claim 1, wherein, when the first display device displays the first picture-in-picture video stream, the first display device displays a first sub-picture and a second sub-picture that overlap with each other, and the first sub-picture and the second sub-picture respectively display the first video stream and the second video stream.

4. The video processing device according to claim 1, wherein, when the first display device displays the first picture-by-picture video stream, the first display device displays a first sub-picture and a second sub-picture that are arranged side by side and do not overlap with each other, and the first sub-picture and the second sub-picture respectively display the first video stream and the second video stream.

5. The video processing device according to claim 2, wherein the first scaling control module further includes a screen display processing circuit, the screen display processing circuit is connected to the video synthesis circuit, and the screen display processing circuit generates an on-screen display menu according to an on-screen display activation command.

6. The video processing device according to claim 5, wherein the screen display processing circuit includes an embedded display output port, the embedded display output port is connected to a video output port of the first scaling control module, and the embedded display output port outputs the on-screen display menu.

7. The video processing device according to claim 5, wherein, when the first display device displays the first picture-in-picture video stream, the first display device displays a first sub-picture and a second sub-picture that overlap with each other, the first sub-picture and the second sub-picture respectively display the first video stream and the second video stream, and the on-screen display menu overlaps with the first sub-picture or the second sub-picture.

8. The video processing device according to claim 5, wherein, when the first display device displays the first picture-by-picture video stream, the first display device displays a first sub-picture and a second sub-picture that are arranged side by side and do not overlap with each other, the first sub-picture and the second sub-picture respectively display the first video stream and the second video stream, and the on-screen display menu overlaps with the first sub-picture or the second sub-picture.

9. The video processing device according to claim 1, further comprising a control interface, wherein the control interface outputs the picture-in-picture mode command and the picture-by-picture mode command.

10. The video processing device according to claim 1, further comprising a second scaling control module, wherein the second scaling control module is connected to the first hub and the second hub, the second scaling control module obtains a third video stream and a fourth video stream respectively from the first hub and the second hub, and the second scaling control module is configured to connect to a second display device; wherein, when the second scaling control module receives the picture-in-picture mode command, the second scaling control module combines the third video stream and the fourth video stream to generate a second picture-in-picture video stream, and the second display device displays the second picture-in-picture video stream; wherein, when the second scaling control module receives the picture-by-picture mode command, the second scaling control module combines the third video stream and the fourth video stream to generate a second picture-by-picture video stream, and the second display device displays the second picture-by-picture video stream.

11. A video processing method supporting free pairing of a picture-in-picture mode and a picture-by-picture mode, the video processing method comprising:
obtaining, by a first hub, a first video stream from a first signal source;
obtaining, by a second hub, a second video stream from a second signal source; and
receiving, by a first scaling control module, the first video stream and the second video stream respectively from the first hub and the second hub;
wherein, when the first scaling control module receives a picture-in-picture mode command, the first scaling control module combines the first video stream and the second video stream to generate a first picture-in-picture video stream, and a first display device displays the first picture-in-picture video stream;
wherein, when the first scaling control module receives a picture-by-picture mode command, the first scaling control module combines the first video stream and the second video stream to generate a first picture-by-picture video stream, and the first display device displays the first picture-by-picture video stream.

12. The video processing method according to claim 11, wherein generating the first picture-in-picture video stream includes overlapping the first video stream with the second video stream to generate the first picture-in-picture video stream, and generating the first picture-by-picture video stream includes arranging the first video stream and the second video stream side by side to generate the first picture-by-picture video stream.

13. The video processing method according to claim 11, wherein displaying the first picture-in-picture video stream includes displaying a first sub-picture and a second sub-picture that overlap with each other, and the first sub-picture and the second sub-picture respectively display the first video stream and the second video stream.

14. The video processing method according to claim 11, wherein displaying the first picture-by-picture video stream includes displaying a first sub-picture and a second sub-picture that are arranged side by side and do not overlap with each other, and the first sub-picture and the second sub-picture respectively display the first video stream and the second video stream.

15. The video processing method according to claim 12, further comprising: receiving an on-screen display activation command by a screen display processing circuit of the first scaling control module; and generating an on-screen display menu by the screen display processing circuit.

16. The video processing method according to claim 15, further comprising: embedding the on-screen display menu in the first picture-in-picture video stream or the first picture-by-picture video stream by the screen display processing circuit; and transmitting the first picture-in-picture video stream or the first picture-by-picture video stream that includes the on-screen display menu to a video output port of the first scaling control module by an embedded display output port of the screen display processing circuit.

17. The video processing method according to claim 15, wherein, when the first display device displays the first picture-in-picture video stream, the first display device displays a first sub-picture and a second sub-picture that overlap with each other, the first sub-picture and the second sub-picture respectively display the first video stream and the second video stream, and the on-screen display menu overlaps with the first sub-picture or the second sub-picture.

18. The video processing method according to claim 15, wherein, when the first display device displays the first picture-by-picture video stream, the first display device displays a first sub-picture and a second sub-picture that are arranged side by side and do not overlap with each other, and the first sub-picture and the second sub-picture respectively display the first video stream and the second video stream, and the on-screen display menu overlaps with the first sub-picture or the second sub-picture.

19. The video processing method according to claim 11, wherein the picture-in-picture mode command and the picture-by-picture mode command are outputted by a control interface.

20. The video processing method according to claim 11, further comprising: obtaining, by a second scaling control module, a third video stream and a fourth video stream respectively from the first hub and the second hub; wherein, when the second scaling control module receives the picture-in-picture mode command, the second scaling control module combines the third video stream and the fourth video stream to generate a second picture-in-picture video stream, and a second display device displays the second picture-in-picture video stream; wherein, when the second scaling control module receives the picture-by-picture mode command, the second scaling control module combines the third video stream and the fourth video stream to generate a second picture-by-picture video stream, and the second display device displays the second picture-by-picture video stream.
